(19) United States
(12) Patent Application Publication
(10) Pub. No.: US 2005/0240435 A1
(43) Pub. Date: Oct. 27, 2005

(54) System and methods for producing medical information reports

(76) Inventors: Karen K. Patalano, Boylston, MA (US); James J. Patalano, Boylston, MA (US)

Correspondence Address: BRIAN M. DINGMAN;MIRICK, O'CONNELL, DEMALLIE & LOUGEE, LLP, 100 FRONT STREET, WORCESTER, MA, 01608, US

(21) Appl. No.: 11/073,334

(22) Filed: Mar. 4, 2005

Related U.S. Application Data
(60) Provisional application No. 60/550,145, filed on Mar. 4, 2004.

(51) Int. Cl. G06F 17/60

(52) U.S. Cl. 705/2

(57) ABSTRACT

A method of producing a medical information report corresponding to one or more facilities comprising the steps of, entering data into a computer corresponding to a patient of the facility; automatically analyzing the entered data and assigning one or more patient care codes, using one or more predetermined criteria, to the data and storing the data and the assigned codes in an electronic database; entering a report query; automatically analyzing and converting the patient codes corresponding to the report query into report codes; generating a report in response to the report query.

### CROSS-REFERENCE

This is a continuation-in-part of U.S. Application Ser. No. 60/550,145, filed on Mar. 4, 2004.

### COPYRIGHT NOTICE AND AUTHORIZATION

Portion of the documentation in the patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF THE INVENTION

This invention relates to medical information reports and more specifically to an automated system and method for analyzing medical information and producing medical information reports.

### BACKGROUND OF THE INVENTION

According to federal government statistics, almost half of all Americans over the age of 65 will rely on nursing home care at some point in their lives and, of these, two out of three will have at least part of their care covered by Medicaid, a joint federal-state program. Under the Medicaid system, the individual states set their own nursing home payment rates. These rates are typically based on the nursing homes' actual costs and some develop these rates specific to each nursing home. Nursing home costs are generally divided into categories to determine payment rates. These categories are typically direct resident care, indirect care, administrative, and capital.

Direct resident care includes costs such as nursing staff salaries, wages, and benefits. Indirect care includes costs such as dietary, medical supplies, laundry, social services, activities, and maintenance. Administrative costs include administrative salaries, expenses, and office supplies. Capital costs include building and equipment such as depreciation, taxes, interest, and rent.

Each state reimburses the nursing facilities within its confines and then the federal government reimburses the state for a portion of the state's Medicaid spending based on a federal formula that is based on a state's per capita income relative to the national per capita income.

Massachusetts uses a case-mix system to tie payment to the costs associated with a given nursing home's current resident care needs. To do so, Massachusetts classifies the nursing homes based on the level of care required and then adjusts payment rates to reflect the costs attributable to a facility's current residents based on their different levels of resident care needs. Rate adjustments generally occur four times a year.

Massachusetts uses a per diem or daily payment rate that is a flat rate for all homes based on a median of all home costs but with some adjustments. Nursing homes in Massachusetts are required to submit information about their nursing needs for Medicaid residents using a reporting system known as the Management Minutes Questionnaire (MMQ). MMQ reports must be submitted on a regular basis. The thoroughness and correctness of these reports are essential for reimbursement. Other states have similar reporting systems.

Preparing the MMQ reports is a labor and time intensive activity. The nursing staff at each facility is responsible for preparing the MMQ reports. The nursing staff prepares the reports using numerous disparate sources including, but not limited to, medication tracking records, doctors orders, progress sheets, and daily professional nursing summaries.

The MMQ process of reporting is prepared on paper by hand writing all summaries and manually converting codes during the preparation of summaries and final reports. Certified nursing assistants (CNA) write CNA flow sheets, nurses write nursing summary forms and the MMQ nurse combines all this information to form the MMQ reports each month. The reports in many cases are incomplete and due to code conversion errors produce discrepancies when audited.

### SUMMARY OF THE INVENTION

It is therefore a primary object of this invention to provide a system and method for producing medical information reports that is automated, efficient, and accurate.

It is a further object of this invention to provide a system and method for producing medical information reports that uses a database platform to quickly store and retrieve patient information while also reducing errors.

It is a further object of this invention to provide a more consistent and predictable system and method for producing medical information reports.

This invention was developed to replace or improve manual reporting systems, such as the Commonwealth of Massachusetts' Management Minutes Questionnaire (MMQ) reporting system. The invention uses a database platform to store and retrieve patient information quickly and through conversion logic produce analytical reports based on the medical information, such as Massachusetts' required MMQ reports.

Information is entered through a series of computer data entry forms. This information is then stored in databases. The invention reduces errors and labor in producing a final report; while developing a more consistent method of entering and reporting data relating to MMQ information. The invention allows for easier editing of patient information and the ability to incorporate the series of logical comparison on the stored data to analyze patient's progress.

The system and methods were specifically designed to reduce errors, confusion and effort found in the traditionally manual system by the use of computer database technology. This system automatically converts codes so that information is properly evaluated and displayed on the MMQ reports. The system can be easily updated each month simply by editing information that is needed without having to hand write the entire report. The system reduces human error and labor by processing the stored data using a series of forms, queries and reports that are specifically developed for patient information relating to the MMQ reporting system. The preferred method of the invention for producing medical information reports corresponding to one or more facilities generally comprises the steps of: entering data into a computer corresponding to a patient of the facility; automatically analyzing the entered data and assigning one or more patient care codes, using one or more predetermined criteria, to the data and storing the data and the assigned codes in an electronic database; entering a report query; automatically analyzing and converting the patient codes corresponding to the report query into report codes; generating a report in response to the report query.

The method may further comprise the step of calculating one or more patient scores based on one or more of the patient care codes, wherein the patient score is reported on the report.

The report query is preferably selected from a group of consisting of, licensed nursing summary, CNA code worksheet, Management Minutes Questionnaire, MMQ Evaluators Report, Administrative Report, Clinical Report, Consultant Report, and Archived Report.

The method may further comprise the step of, providing one or more data entry forms to facilitate the step of entering data.

The facility is preferably a nursing home and the report preferably comprises nursing home costs, wherein the report comprises direct resident care costs, indirect care costs, administrative costs, and capital costs. The data entered in the step of entering data is preferably selected from a group consisting of, direct resident care data, indirect care data, administrative data, and capital data.

The report may also comprise an administrative report, wherein the administrative report comprises a report selected from a group consisting of scores by unit, scores by payer source, staffing, and due dates. The report may further comprise a clinical report, wherein the clinical report comprises a report selected from a group consisting of weight loss, weight gain, missing weight, Norton score, positioning, ambulation, mobility, skilled observations, decubitus treatments, skilled nursing procedures, restorative nursing, behavior report, restraints report, contracture report, and accidents report.

The codes assigned may be selected from a group of consisting of, bath codes, ambulation codes, behavior codes, bladder codes, bowel codes, decubitus codes, dressing codes, eating codes, grooming codes, intervention codes, toileting codes, and transfer codes. The preferred embodiment of the system of the invention for producing a medical information report corresponding to a care facility generally comprises: an electronic database for storing medical information data; a means for entering the data into the database; a plurality of data forms for facilitating the entry of data; a means for automatically analyzing and converting the entered data into patient care codes; and a means for generating a report comprising the patient care codes. The system may further comprise a means for automatically analyzing and converting the patient care codes into patient scores, wherein the report may further comprise the patient scores.

The patient care codes are preferably selected from a group consisting of bath codes, ambulation codes, behavior codes, bladder codes, bowel codes, decubitus codes, dressing codes, eating codes, grooming codes, intervention codes, toileting codes, and transfer codes.

Where the report comprises a Management Minutes Questionnaire report, the report preferably comprises nursing home costs such as direct resident care costs, indirect care costs, administrative costs, and capital costs.

### BRIEF DESCRIPTION OF THE DRAWINGS

Other objects, features and advantages will occur to those skilled in the art from the following description of the preferred embodiments and the accompanying drawings in which:

FIG. 1 is a functional flowchart of the steps of the method of the preferred embodiment of the invention;

FIG. 2 is a sample user screen for initiating data entry into one or more of the databases of the preferred embodiment of the invention;

FIG. 3 is a sample user screen for entering a code from a CNA flow sheet of the preferred embodiment of the invention;

FIG. 4 is a sample user screen of the preferred embodiment of the invention for entering data into the patient information database;

FIG. 5 is a sample user screen of the preferred embodiment of the invention for entering data about bathing, grooming, and dressing information;

FIG. 6 is a sample user screen of the preferred embodiment of the invention for entering data about mobility, eating, elimination, and positioning information;

FIG. 7 is a sample user screen of the preferred embodiment of the invention for entering data about decubitus and special attention information;

FIG. 8 is a sample user screen of the preferred embodiment of the invention for entering data about restorative information;

FIG. 9 is a sample user screen of the preferred embodiment of the invention for entering MMQ information about questions 17-24;

FIG. 10 is a sample list of forms used to enter data into one or more of the databases of the preferred embodiment of the invention;

FIG. 11 is a sample list of databases of the preferred embodiment of the invention;

FIG. 12 is a sample list of queries used to extract information from one or more of the databases of the preferred embodiment of the invention;

FIG. 13 is a sample list of reports that may be generated from the preferred embodiment of the invention;

FIG. 14 is a sample design of a database of the preferred embodiment of the invention;

FIG. 15 is a sample query page for extracting resident information from one or more databases of the preferred embodiment of the invention;

FIG. 16 is a sample report page for an MMQ report that may be generated from one or more of the databases of the preferred embodiment of the invention;

FIG. 17 is a partial sample evaluator's report that may be generated from one or more of the databases of the preferred embodiment of the invention;

FIG. 18 is a sample logic statement used to convert codes using the preferred embodiment of the invention;

FIG. 19 is a sample table of database relationships of the preferred embodiment of the invention;

FIG. 20 is a sample user screen for selecting a clinical report to be generated using the preferred embodiment of the invention; and

FIGS. 21A and B is a sample list of report descriptions and queries corresponding to the user screen shown in FIG. 20.

### DETAILED DESCRIPTION OF THE PREFERRED EMBODIMENT AND METHODS

The invention utilizes a database platform to store and retrieve patient information quickly and through conversion logic produce a medical cost information report such as Massachusett's required MMQ report. The system and methods of the invention were developed to replace a manual MMQ reporting system used by nursing homes to report nursing home costs to the state. In the preferred embodiment, information is entered into the database through a series of computer data entry forms. This information is then stored in databases. The invention reduces errors and labor in producing a final report, while developing a more consistent method of entering and reporting data relating to MMQ information. The invention allows for easier editing of patient information and the ability to incorporate the series of logical comparison on the stored data to analyze patient's progress. Although initially adapted for use in accordance with Massachusetts regulations, the system and methods of the invention are filly adapted for use in any jurisdiction and for a variety of reporting applications.

The system and methods of the invention are used in the context of a facility that provides nursing home care or other similar types of medical assistance and care. Such facilities other voluntarily or as required to comply with state and federal laws and regulations, collect, maintain, and generate reports on the costs and care associated with the operation of these facilities. The terms facilities and medical information reports are used herein in such contexts.

In Massachusetts, an MMQ is required for reimbursement for each new Division of Medical Assistance resident at the time of admission to the facility or at conversion from private or Medicare payment to Medical Assistance payment. Below is a brief, partial description of Massachusetts MMQ requirements.
The Clinical Record is the source for information to complete the MMQ. Documentation must be current, accurate, and signed by the person performing the care. The licensed nursing summary, daily licensed nursing notes, physician's orders and progress notes, ADL flow sheets, medication administration records, treatment records, and care plans should all be reviewed for completing the MMQ. Documentation for assistance with activities of daily living must be associated with resident dysfunction, and the reason given for assistance must relate to this dysfunction as described in the medical care plan.
Documentation must be current, accurate, and signed by the person performing the care.

For example, nurses may not indicate how nurse's aides are to complete an ADL flow sheet by highlighting, circling or otherwise marking items. Any changes to entries in the medical record must be initialed and dated leaving the original entry legible. Only individuals who made the original entry may change that entry. Late entries, for the purpose of correction, must be made by a licensed nurse within 30 days of the original entry.
The resident's score and category are based upon the services rendered and recorded through nurse and nurse's aide documentation. When conflicting documentation exists between the licensed nurse and the nurse's aide, the lesser point value will be applied. Justification for assistance with activities of daily living and special attention must be associated with the resident's clinical and functional status as documented by the licensed nurse.
The MMQ may be completed by a licensed nurse but must be signed by a registered nurse. In order to ensure accuracy and objectivity, the licensed nurse who is responsible for direct resident care should complete the monthly Nursing Summary, and should not be the same licensed nurse who completes the MMQ.
The code and score must be entered for every item. The code is listed on the left and the appropriate score is on the right for each item. Example: C4/S48 reads—Code 4 and Score 48. Codes are entered in the boxes and scores are entered on the lines. (Nursing Facilities Participating in the Medical Assistance Program from Bruce M. Bullen, Commissioner, entitled Medical Assistance Program Nursing Facility Bulletin 108, August 1995, Revised MMQ Instructions.)

The system and methods of the invention are used in connection with a computer and an electronic database accessible via the computer and a printer for printing the reports of the invention. The system and methods may be adapted for a single or multiple computer systems, for personnel computers, laptops and handheld devices. The system may utilize direct or remote connections through any appropriate means including wired and wireless means depending on the application.

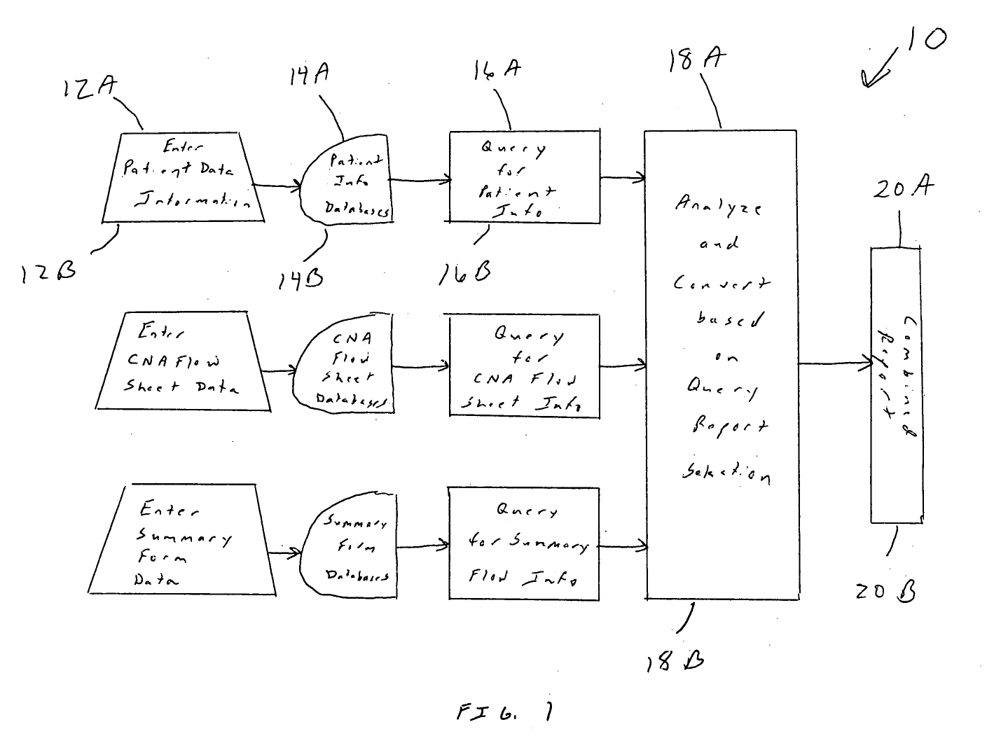

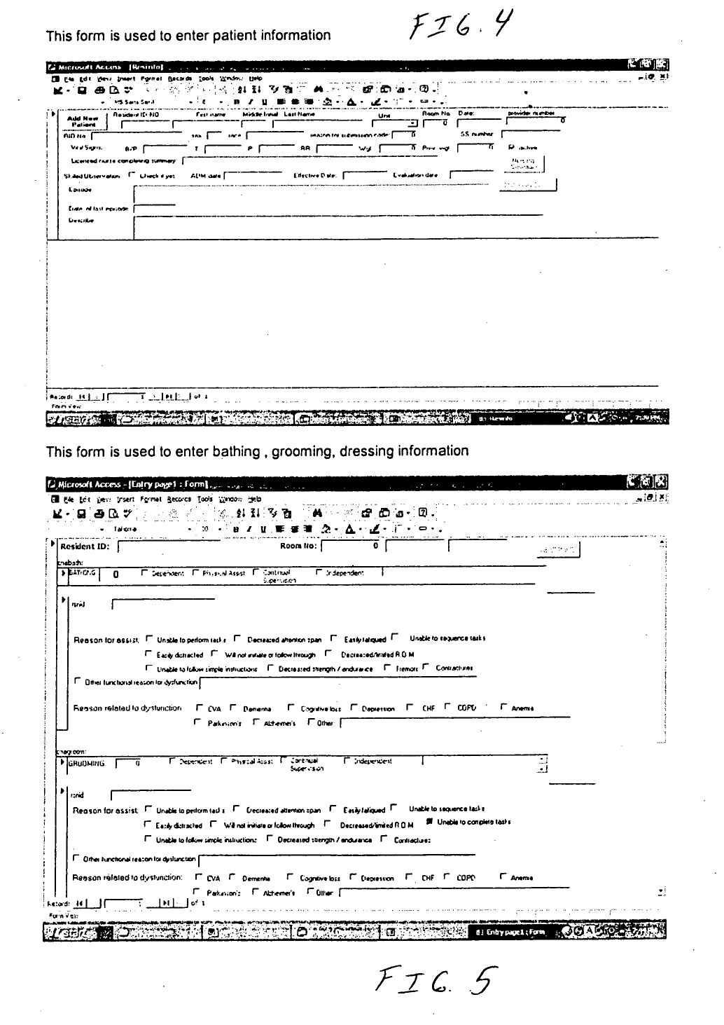

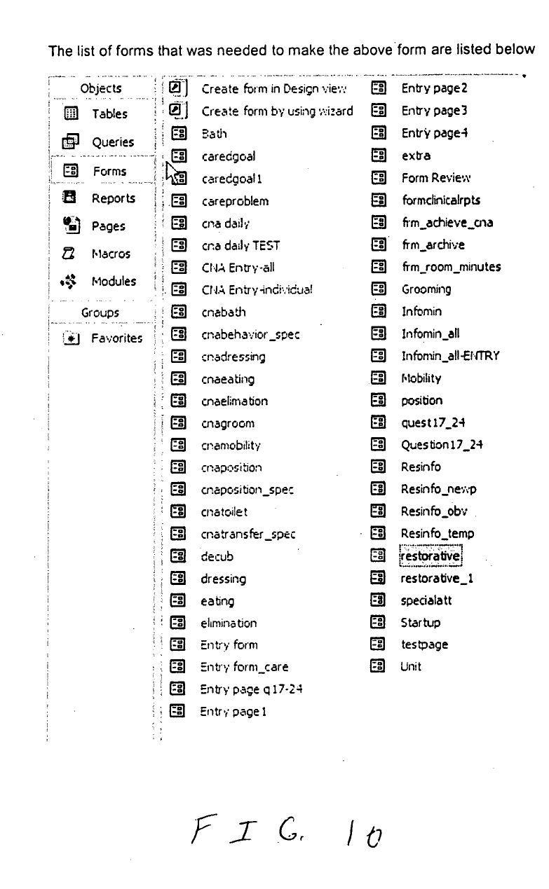

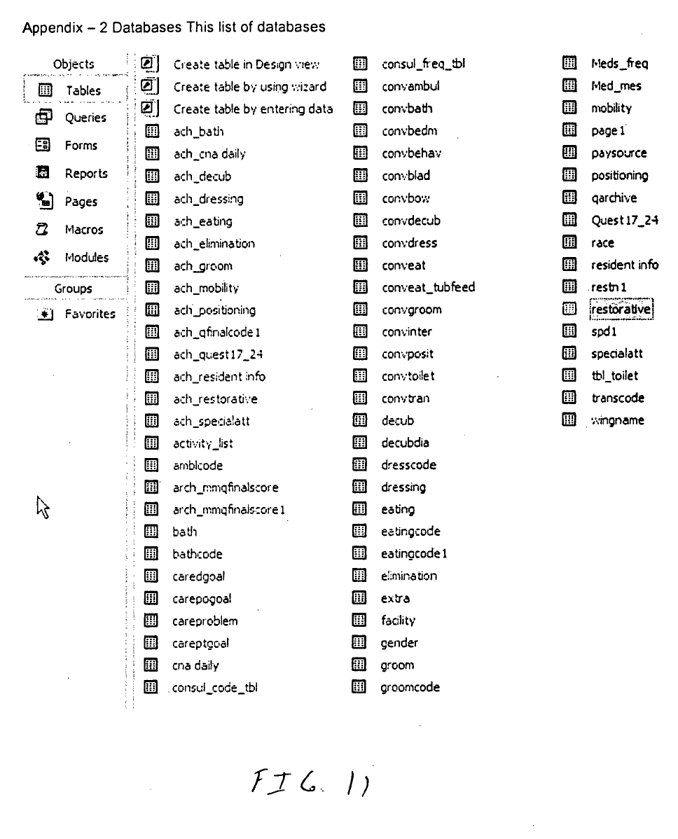

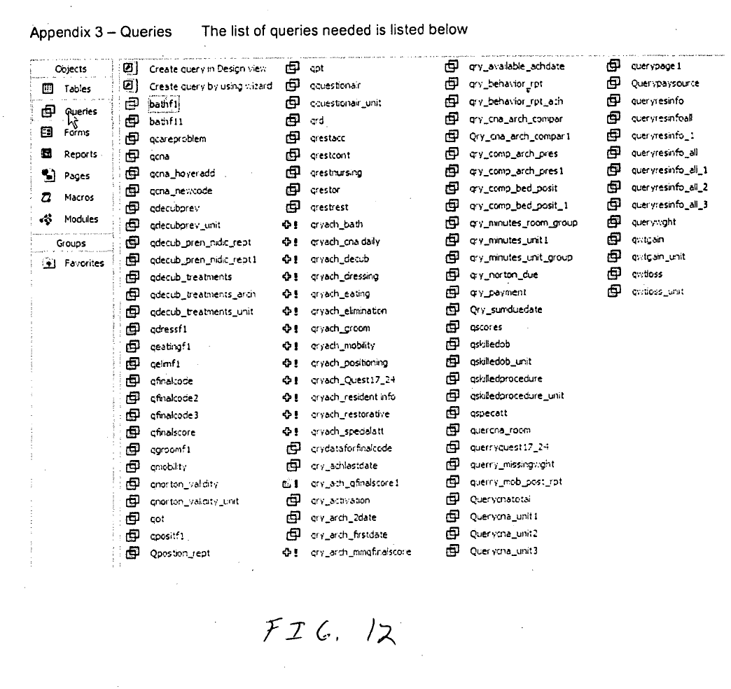

As shown in the flowchart of FIG. 1, the preferred embodiment of the system, generally referred to as system 10, is designed for entering cost information into database 16A using entering means 12A and producing the MMQ reports by the means for analyzing and converting codes 14A and scores 16A. Specifically developed forms, shown in FIGS. 3-9, are used to enter data while using screen notes to alert data entry personnel about actual or potential mistakes that might result in MMQ report discrepancies. Data is entered in step 12B and stored in different databases 14A in step 14B to allow for efficient data retrieval. The type of forms and databases used will depend on the requirements of a given reporting system. The preferred embodiment is based on Massachusetts' MMQ reporting requirements. However, the system and methods of the invention are not limited to the MMQ requirements or to the forms and databases described herein. The invention is readily adapted to other types of reporting requirements.

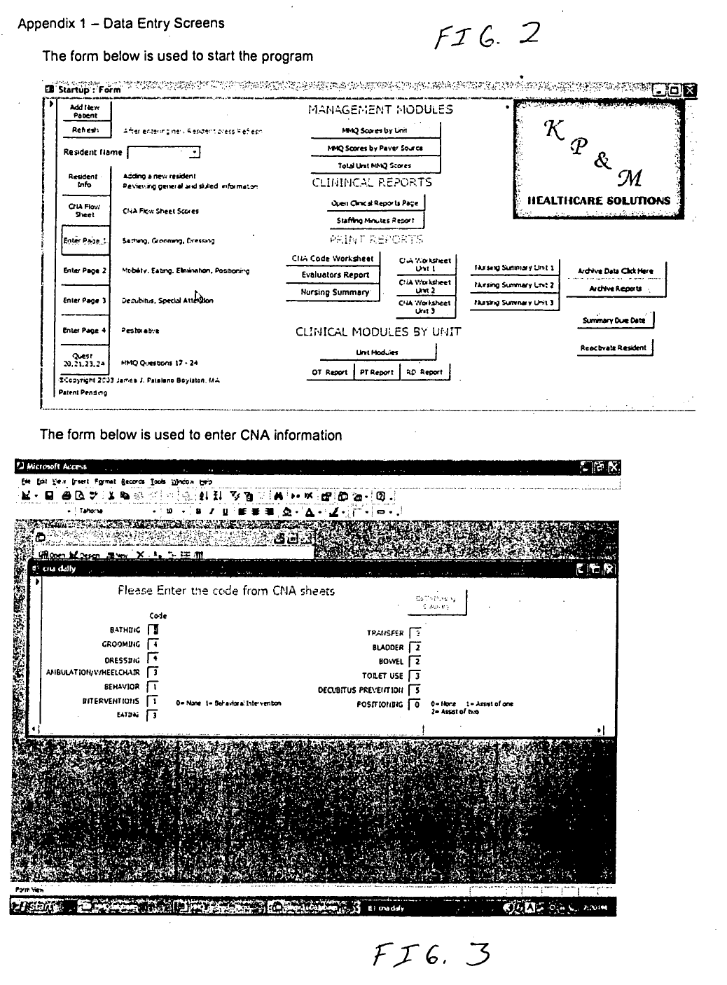

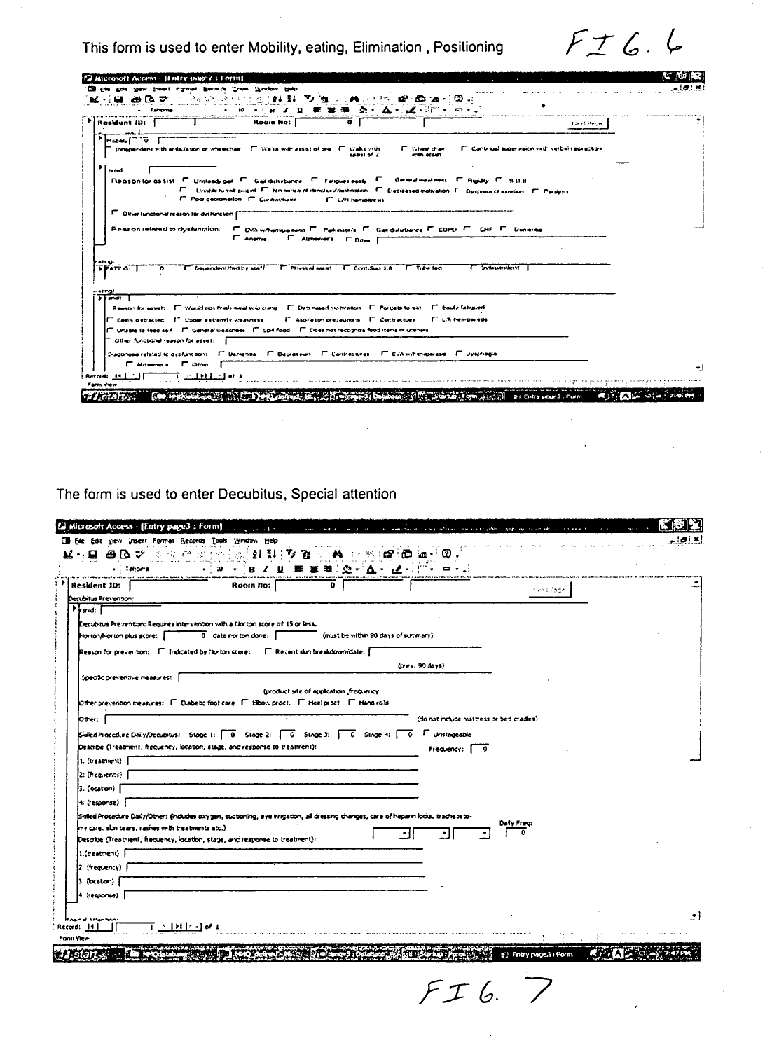

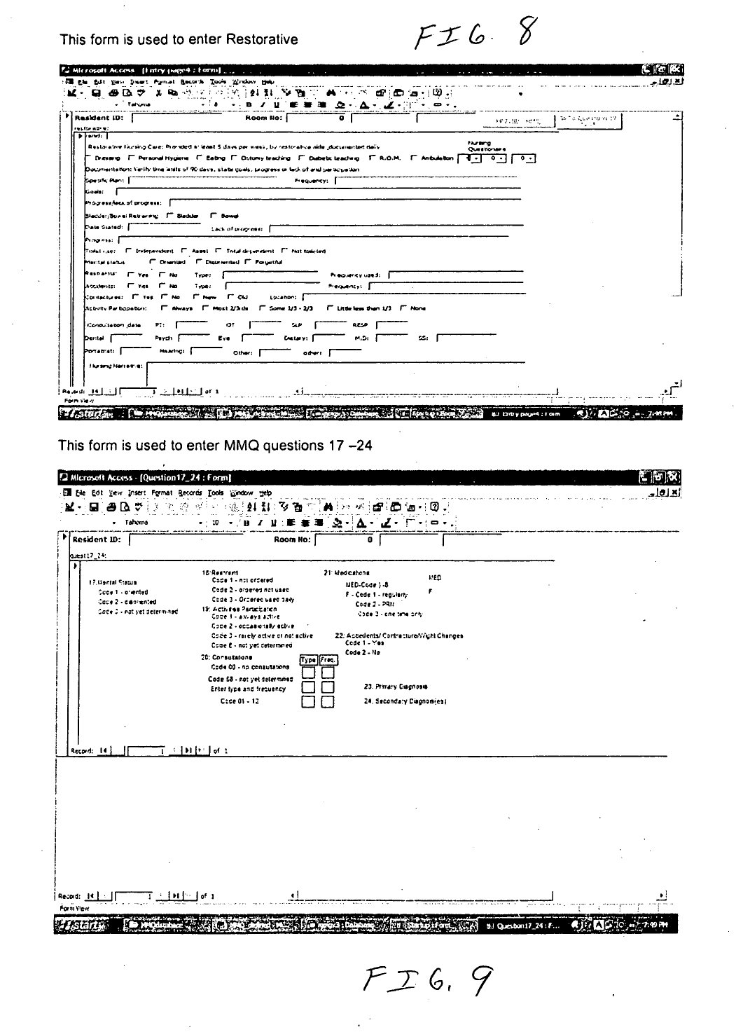

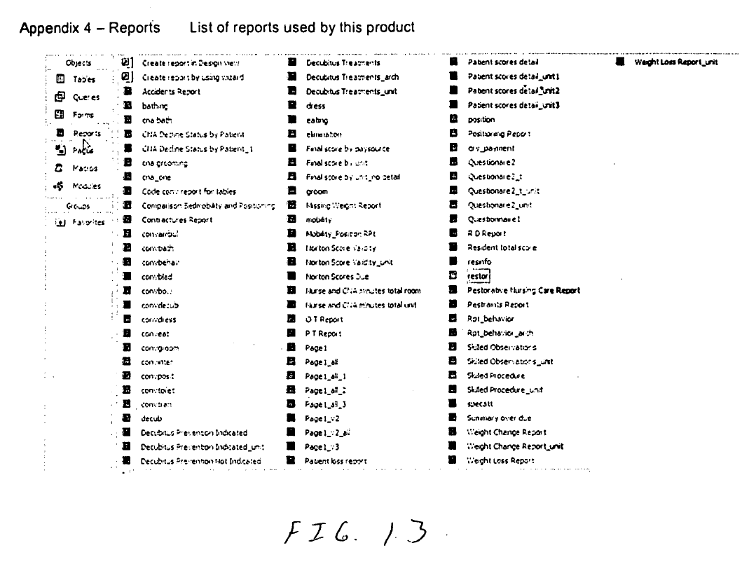

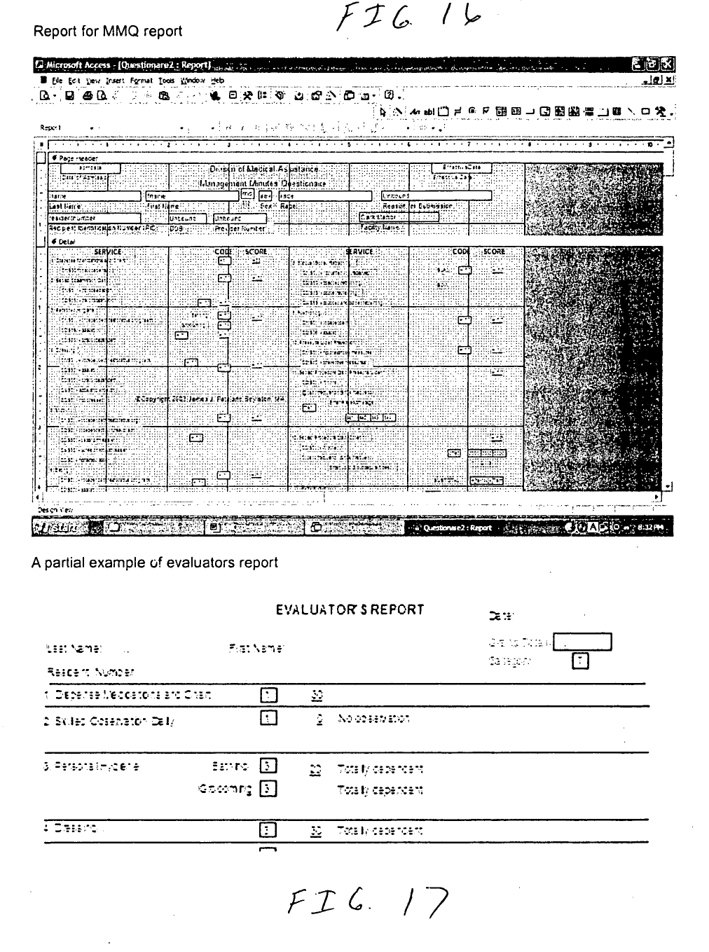

The flow of information starts by opening the user Startup screen shown in FIG. 2 and selecting a database for entry. Data is then entered into the selected database in step 12 using the data entry form, corresponding to the selected database, including but not limited to: Patient Information (FIG. 4), CNA flow sheets (FIG. 3), and various summary forms (FIGS. 5-9). For example, the Patient information form is used to initially enter general information about patients into the Resident info database. The CNA flow sheets form is used to enter CNA flow sheet information into the CNA daily database (FIG. 14). After the information using the Patient Information and CNA flow sheet forms is entered and saved into the respective databases, this more generally applicable information can then be selectively recalled and used to facilitate the entry of additional information from the summary forms that is more specific to individual patients. An illustrative list of selectable forms is shown in FIG. 10 and their corresponding databases is shown in FIG. 11.

In the preferred system and method, four Summary pages are used to enter additional information. Summary page 1 is used to enter bathing, grooming and dressing information into appropriate database.
Summary page 2
   This form is used to enter mobility, eating, elimination and positioning information into appropriate database.
Summary page 3
   This form is used to enter decubitus and special attention information into appropriate database.
Summary page 4
   This form is used to enter Restorative information into appropriate database.
Additional entry Management Minutes Questionnaire (MMQ)
   This form is used to enter MMQ questions 17-24 information into appropriate database.

The preferred embodiment of the system of the invention utilizes Microsoft's Access Database as the preferred engine to build the database. As noted, the system of the preferred embodiment of the invention is adapted for use in connection with Massachusetts' MMQ reporting requirements. As such, it comprises eighteen customized databases, thirty-five data entry forms, twenty logic queries and twenty-three reports in order to complete MMQ reports.

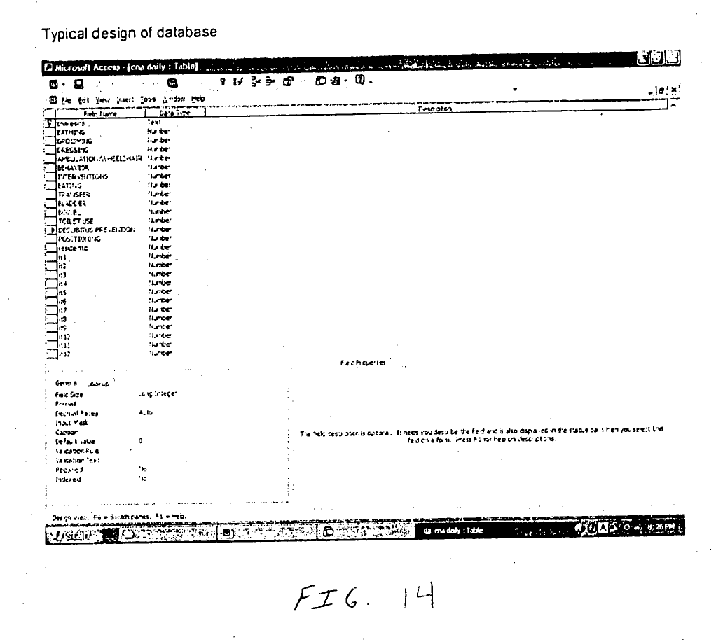

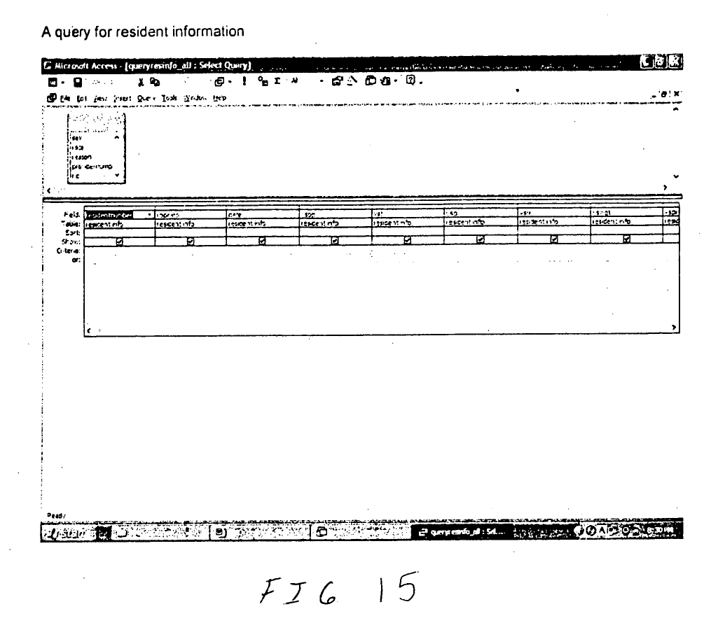

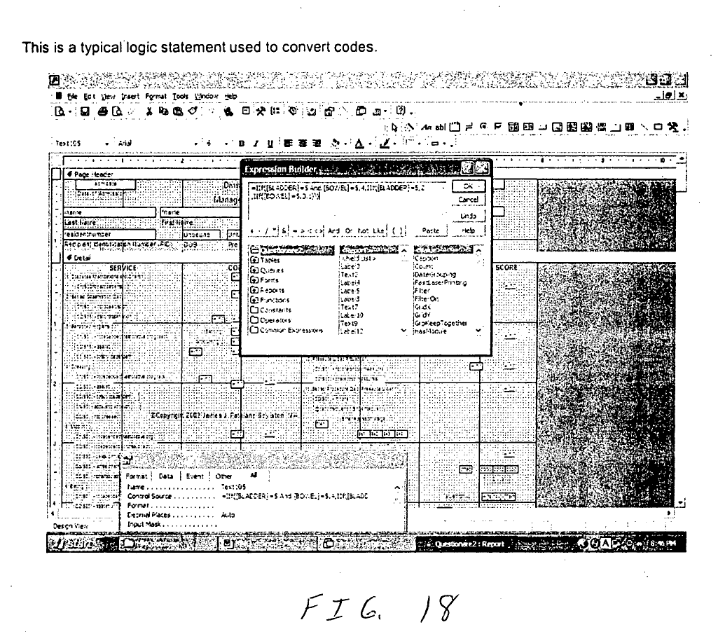

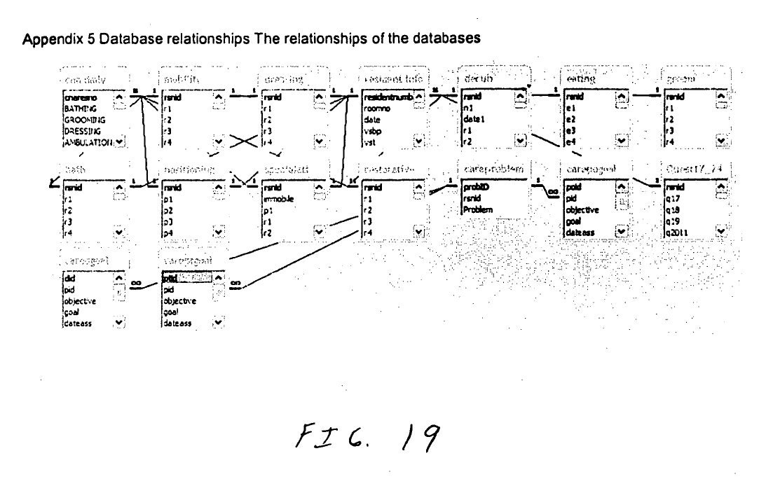

The information that is stored in the databases of the preferred embodiment uses Queries (FIG. 12) with specifically developed logic to produce a variety of reports (FIG. 13) in steps 18B and 20B such as an MMQ report shown in FIG. 16 or an Evaluator's report, partially shown in FIG. 17, using the means for generating reports 18A and 20A. For example, a query user page for residential information is shown in FIG. 15.
Licensed Nursing Summary
CNA Code Worksheet—Resident CNA codes and the assistance description for each Activity of Daily Living (ADL).
Management Minutes Questionnaire
MMQ Evaluators Report—MMQ Scores, codes, Letter Category, and ADL assistance description.
   Administrative Reports:
MMQ Scores by Unit—MMQ scores, letter score, number of points to the next category.
MMQ Scores by Payer Source—MMQ scores, letter score, number of points to the next category.
Staffing Report—According to the MMQ minutes, this report identifies the time that should be allocated for licensed nursing and nurses aides per unit. This report is used to assure that there is adequate staff scheduled per unit and can identify potential overstaffing according to the care being documented.
Summary Due Date—The last date the residents were updated in the system.
   Clinical Reports:
Weight Loss—Identifies residents who have had a greater than five pound weight loss. Eating ADL category and Mental Status are printed on this report. Used to initiate an increase in the level of care the resident receives while eating.
Weight Gain—Identifies residents who have had a greater than five pound weight gain. Eating ADL category and Mental Status are printed on this report.
Missing Weights—Identifies all residents that did not have a monthly weight documented on the licensed nursing summary.
Decubitus Prevention Indicated—All residents who have a Norton Score of 15 or less and preventive measures are not documented on both the CNA flow sheet and the Licensed Nursing Summary. These residents should be receiving measures to prevent the occurrence of decubitus ulcers.
Decubitus Prevention with Norton >15—Identification of residents that are receiving decubitus prevention without indication or payment.
Norton Score Validity—Residents who have a Norton Score of 15 or less and are continent and ambulatory are identified with the weight change for the month noted. These residents should have their Norton Score recalculated.
Norton Score Due—Identification of residents that have not had their Norton Score calculated within 90 days.
Positioning—Residents who need assistance with transfer and are not being positioned are identified. The report also documents continence status of bowel and bladder and the Norton Score. These residents should be assessed for the need for positioning. They may be at risk for development of decubitus ulcers without positioning.
Positioning & Ambulation—Identification of residents who ambulate independently or with supervision and are being positioned. Residents identified on this report should have their ambulation status and/or their need for positioning assessed.
Bed Mobility & Positioning—Identification of residents who are assisted with bed mobility and their positioning status noted. Residents who are assisted with bed mobility and are not being positioned should be assessed for the need for positioning.
Skilled Observations—This report describes all the Skilled Observations, episode and the date of episode that occurred during the month for all residents in the facility. It can be used as a tool to improve the quality of the doctor's orders and/or documentation.
Decubitus Treatments—This report prints all the Decubitus Treatments occurring in the facility. The documentation includes staging, frequency, location and results. It can be used as a tool to improve the quality of the doctor's orders and/or documentation. It can be used by the wound nurse to complete audits on residents with decubitus ulcers.
Skilled Nursing Procedures—This report describes the Skilled Nursing Procedures occurring monthly in the facility. The documentation includes staging, frequency, location and results. It can be used as a tool to improve the quality of the doctor's orders and/or documentation.
Restorative Nursing—The restorative plan, frequency, goals, progress and restorative category is printed on this report. This report should match the Restorative Report maintained by the restorative aide.
Behavior Report—The behavior report describes the type and behavior, intervention, number of days, and if there is a behavior care plan or a psychiatric consult in place.
Restraints Report—All residents with restraints, including the type and frequency are identified. This report can be used for restraint reduction and monitoring. It can also be used to identify which residents need their lap belts released at mealtimes.
Contractures Report—The contractures report identifies residents with new and old contractures and their location. All residents with a new contracture should be evaluated for cause and plan of care.
Accidents Report—This report can be used as a monthly log of all accidents that occurred. This report should match the Incident & Accident reports filed for the month.
   Consultant Reports:
Physical Therapy (PT) Report—The PT Report prints out the level of assistance each resident receives for transfer and ambulation.
Occupational Therapy (OT) Report—The OT Report prints out the level of assistance each resident receives for bathing, grooming and dressing.
Registered Dietitian (RD) Report—The RD Report prints out the level of assistance for eating each resident receives.
   Archived Reports:
Decline in Activity of Daily Living (ADL) Report—This report identifies a decline in any ADL for all residents. Interventions should be instituted for any decline, especially in ambulation and eating to prevent negative outcomes.
Decubitus Treatments—Two or more months of Decubitus treatment reports are available to determine residents that have recurring, improving or worsening wounds. This report can be used for identifying residents with worsening wounds who require a treatment change.
Behavioral Reports—Residents who are experiencing the same or worsening behaviors month after month can be readily identified. This report can be used to monitor the effectiveness of an intervention or a behavior treatment plan.

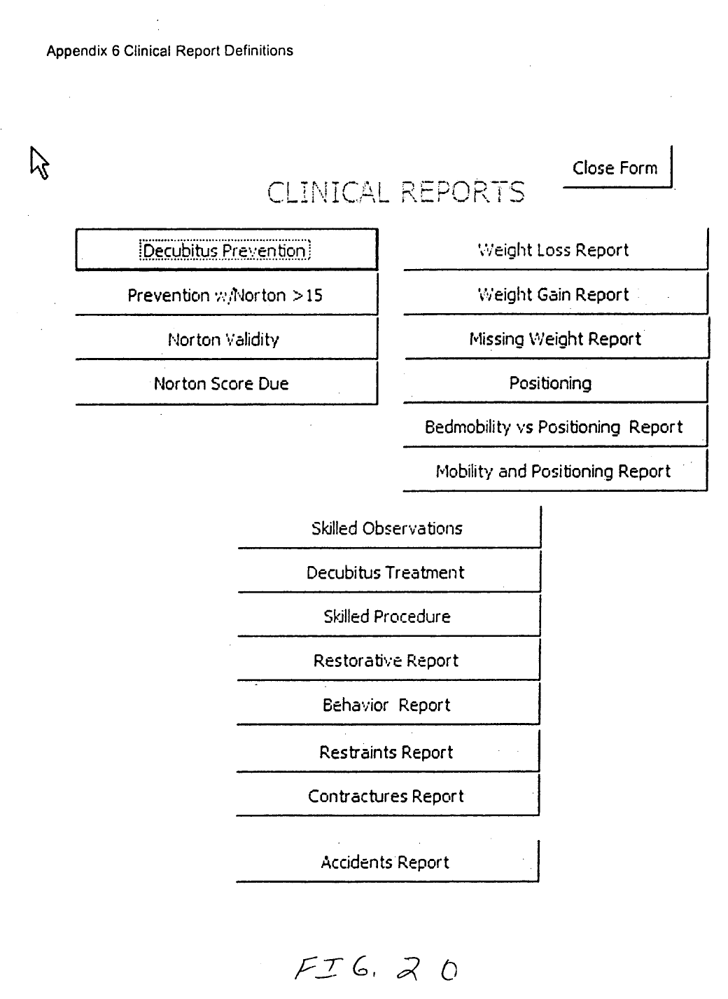

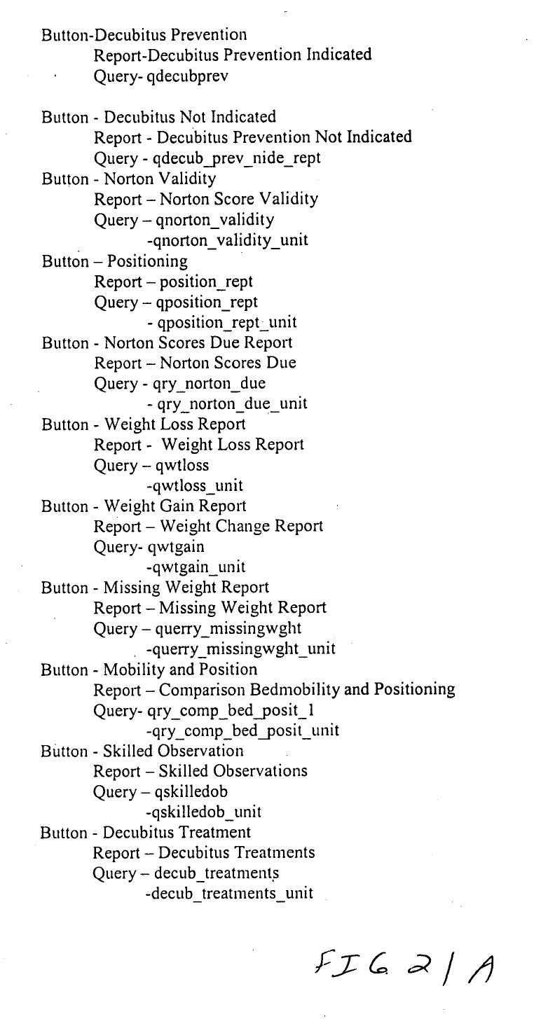

The logic used in the program of the invention is both Boolean and if then statements. This logic is used to analyze codes on the CNA flow sheet and summary sheets. FIG. 18 provides an example of this type of logic as it relates to predetermined database relationships as shown in FIG. 19. The system then converts original patient coding to final MMQ report coding which then can be given a final score to produce the MMQ report. The scores come from MMQ questionnaire directions given out by the Commonwealth of Massachusetts.

To start the system the user activates the startup form (FIG. 2). The startup form allows the users to easily setup a new patient or through a pull down menu, select a specific patient. The following screens are used for this process:
Viewing existing information
Editing existing information
Entering new information
Printing reports The next step is to enter the patient information such as the CNA flow sheet information into the CNA flow sheet form (step 12). At this point the logic step 14 of comparing the codes from CNA sheet to what they should be on the summary sheet happens on the summary form. The converting of codes is done automatically with out data entry assistance. This code changing for the summary pages helps reduce data entry errors for both the summaries and the final report information. The information from both the CNA database and summary database is automatically analyzed in step 18 to produce the MMQ report. The data that has been captured by this system is then combined in step 20 and is used to trigger patient care improvement programs. These programs compare things like weight loss over the months and additional care that is indicated according to standards of practice.

System 10 of the invention automatically converts codes so that the information is properly evaluated and displayed on the reports, including the MMQ reports. System 10 is easily updated by simply editing the information needed without having to hand write the entire report. System 10 is automated, so that when the information coded on the CNA flow sheet is entered, the program automatically checks the correct box on the summary and produces the MMQ as a report.

A separate ADL CNA Flow sheet is preferably maintained monthly for each resident. A CNA enters one code on each shift for all of the following items. Each of the ADL's are coded for each resident each shift depending upon the amount of assistance required during that shift. The following codes are the illustrative base program used in the preferred embodiment that is connected from the CNA data entry form to the Summary to the Evaluators Report and/or the MMQ Report. A front end is added to the base program to accommodate each different customer's actual CNA flow sheets without disturbing the base program.

Bath Codes

0=Description Activity did not occur
1=Description Independent
2=Description Continual Supervision
3=Description Limited Assist
4=Description Extensive Assist
5=Description Total Care
   Ambulation Codes
0=Description Activity Did Not Occur
1=Description Independent
2=Description Continual Supervision
3=Description Limited Assist
4=Description Extensive Assist (1 person)
5=Description Extensive Assist (2 person)
6=Description Total Care (1 person assist)
7=Description Total Care (2 person assist)
8=Description Wheelchair Independent
9=Description Wheelchair Continual Supervision
10=Description Wheelchair Limited Assist
11=Description Wheelchair Extensive Assist (1 person)
12=Description Wheelchair Extensive Assist (2 person)
13=Description Wheelchair Total Care (1 person assist)
14=Description Wheelchair Total Care (2 person assist)
   Behavior Codes
0=Description None Observed
1=Description Behavior problem Observed
   Bladder Codes
1=Description Continent
2=Description Incontinent-Dependent not toileted
3=Description Incontinent-Assist-Toilet Q2hrs
4=Description Foley or condom Catheter
5=Description Continent-Physical Assist
   Bowel Codes
0=Description No BM
1=Description Continent
2=Description Incontinent-dependent not toileted
3=Description Incontinent-assist-toileted Q2hr.
4=Description Colostomy
5=Description Continent-Physical Assist
   Decubitus Codes
0=Description No measures
1=Description Diabetic Foot Care
2=Description Heel, elbow protector
3=Description Lotion, cream
   Dressing codes
0=Description Activity Did Not Occur
1=Description Independent
2=Description Continual Supervision
3=Description Limited Assist
4=Description Extensive Assist
5=Description Total Care
   Eating Codes
1=Description Independent
2=Description Continual Supervision
3=Description Limited Assist
4=Description Extensive Assist
5=Description Total Care
6=Description Tube Fed
7=Description Tube Fed Independent
8=Description Tube Fed Continual Supervision
9=Description Tube Fed Limited Assist
10=Description Tube Fed Extensive Assist
11=DescriptionTube Fed Total Care
   Grooming Codes
0=Description Activity Did Not Occur
1=Description Independent
2=Description Continual Supervision
3=Description Limited Assist
4=Description Extensive Assist
5=Description Total Care
   Intervention codes
0=Description No Intervention
1=Description Intervention
   Positioning Codes
1=Description Independent
2=Description Assist of 1
3=Description Assist of 2
   Toileting Codes
0=Description Activity did not occur
1=Description Independent
2=Description Continual Supervision
3=Description Limited Assist
4=Description Extensive Assist
5=Description Total Care
   Transfer Codes
0=Description Activity Did Not Occur
1=Description Independent
2=Description Continual Supervision
3=Description Limited Assist (1 person)
4=Description Extensive Assist (1 person)
5=Description Extensive Assist (2 person)
6=Description Total Care (1 person assist)
7=Description Total Care (2 person assist)

As described above, the code and score is provided for each item in the MMQ report. According to Massachusetts MMQ reporting instructions, the code is listed on the left and the appropriate score is on the right for each item. Example: C4/S48 reads—Code 4 and Score 48. Codes are entered in the boxes and scores are entered on the lines.

As noted, system 10 utilizes logic to analyze and convert the entered information based on the codes and scores into an MMQ report. Below is a list of logic rules and user instructions used in the preferred system and method. These logic rules and instructions are for illustrative purposes and are not intended to limit the invention.
1. Dispense Meds and Chart (includes all routine documentation)
   CODE 1 SCORE 30 FOR ALL RESIDENTS
   Pouring, delivering, and charting all medications, including psychoactives (see exclusion under Skilled Observation), intermittent I.V. antibiotics, routine infections, PRN medications, eye drops, eye ointments, inhalation aerosols, topical medications, suppositories, miscellaneous brief services such as vital signs that must be taken in conjunction with various medications, routine vital signs, and routine sugar and acetone. All residents receive 30 points since it reflects the necessary presence of a licensed nurse on duty at the nursing unit. The code and score are preprinted on the MMQ.
2. Skilled Observation Daily
   No Documented Observations Required—Code 1, Score 0
   Daily Skilled Observations—Code 2 Score 15
   A skilled observation must be specifically ordered with parameters in writing by a physician, performed by a licensed nurse, and recorded at least daily, e.g. Neurological signs, B/P, and TPR over and above any vital signs that must be taken and recorded as a prerequisite for the administration of certain medication. This also includes any non-routine measurement of a resident's condition, such as the need for suctioning a resident with a tracheostomy, observation of the edema and/or congestion in a resident with congestive heart failure, the need for oxygen and blood tests for insulin administration. This may include the introduction and/or titration of a psychoactive medication for a resident with a diagnosis of a major mental disorder that is defined a one or more of the following: schizophrenia, major affective disorder atypical psychosis, schizoaffective disorder, bipolar depression, unipolar depression or organic mental syndrome with associated psychotic an/or agitated behavior, specifically to titrate the dose for maximum effectiveness, manage unexpected harmful behaviors that cannot be managed without a psychoactive medication.
   NOTE: The resident's condition must indicate the clinical complexity and justify the need for skilled observation, with documentation of a current or recent episode within the past 60 days. Document the date and type of episode.
   Documentation: Daily licensed nursing documentation must be specific to the observation, including the nursing action and effect. Specific observations must be noted daily on a treatment sheet. Each episode must be documented and dated.
   Exclusions: Routine PRN use or tapering of psychoactive medications, aspiration precautions (except in clinically complex situations), and monitoring of temperature and signs and symptoms of infection while ion antibiotic therapy.
3. Personal Hygiene
   Independent—Code 1 score 0
   The resident is independent, assisted only for weekly bath/shower or on a “Restorative Bathing/Grooming” program. Score 0 if both bathing and grooming are Code 1.
   Assist—Code 2 score 18 (See note below)
   Nursing procedures by staff to maintain personal cleanliness and good grooming including attending and/or assisting with bathing, shaving and brushing teeth. Attending means continual supervision while the resident performs the personal hygiene task to ensure completion of the task. Includes routine skin care and the use of all bathing products.
   NOTE: Any degree of resident involvement (washing his/her own face and hands, etc.) is considered an assist.
   Totally Dependent—Code 3 score 20 (See NOTE below)
   Bathing and/or grooming completed entirely by nursing staff without assistance form the resident. “Bath” may take place at bedside, or in a bathing system, shower, or regular tub.
   NOTE: SCORE is based on the highest level of need in either grooming or bathing.
   Example: If the resident is independent in grooming but needs assistance in bathing, the codes are Bathing—2, Grooming—1 and the score is 18.
   Documentation: The Licensed Nursing Summary must verify ADL status at least monthly and specify the reason for assistance. The ADL flow sheet must document the daily functional status of the resident.
   NOTE: If points are scored for bathing or grooming, points may not be scored under “Restorative Bathing or Grooming” program.
4. Dressing
   Independent—Code 1 score 0
   This item includes setting out the resident's clothes. Code 1 if the resident is on a “Restorative Dressing” program.
   Assist—Code 2 score 30 (See NOTE below)
   The resident cannot dress and undress without direct physical, or continual instructional, or continual motivational assistance. This item includes application of all splints (for example, Multipodus or L'nard boots), braces, binders, anti-embolism stockings, and cervical collars. Assistance only with socks and shoes may not be claimed.
   NOTE: Any degree of resident involvement is considered an assist.
   Totally Dependent—Code 3 score 30
   The resident cannot dress and undress.
   Socks and shoes only—Code 4 score 0
   The resident needs assistance with socks, shoes, buttons, bra hooks or zippers only.
   Not Dressed—Code 5 Score 0
   The resident wearing nightclothes only is “not dressed”.
   Documentation: The Licensed Nursing Summary must verify ADL status at least monthly and specify the reason for assistance. The ADL flow sheet must document the daily functional status of the resident.
   NOTE: If points are scored for dressing, points may not be scored under “Restorative Dressing” program.
5. Mobility
   Mobility describes how the resident walks indoors, once in a standing position, or wheels once in a wheelchair. Transfer (Item #16) describes how the resident gets to the standing or sitting position.
   Independent—CODE 1 SCORE 0
   The resident is independent if no staff intervention is necessary. This includes the resident who walks with the assistance of equipment (e.g., uses a walker or a cane or wears a wander guard). Use code 1 if the resident is on a “Restorative Ambulation” program.
   Independent with wheelchair—CODE 2 SCORE 0
   Walks with assist—CODE 3 SCORE 32
   The resident can bear own weight but must be physically steadied (one on one) or guided (standby guard) in ambulation by nursing staff˜or the resident must be continually monitored, supervised, and given verbal instructions.
   Wheelchair with assist—CODE 4 SCORE 32
   Wheelchair resident who cannot move or propel alone, or appropriately, because of mental or physical state; or the resident must be continually monitored, supervised, and given verbal instructions.
   Nonambulatory/bed bound—CODE 5 SCORE 0
   The resident does not move out of his or her bed (non-mobile, bed bound, or bed-to-chair only). NOTE: If points are scored for mobility/ambulation, points may not be scored under “Restorative Ambulation” program.
   Documentation: The Licensed Nursing Summary must verify AOL status at least monthly and specify the reason for assistance. The AOL flow sheet must document the daily functional status of the resident.
6. Eating
   Independent—CODE 1 SCORE 0
   A resident requiring standard tray preparation (uncover all items on tray, open milk carton) but needs no help eating, is independent Cutting up meat is considered standard tray preparation. Code 1 if the resident is on ‘Restorative Feeding’ program.
   Assist—CODE 2 SCORE 20 (See NOTE below.)
   The resident can bring food to mouth. The resident requires intervention by caregiver, including direct physical assistance, or continual individual or small-group supervision (at a ratio no greater than one staff to eight residents) during the entire mealtime.
   NOTE: Any degree of resident involvement is considered an assist.
   Totally dependent—CODE 3 SCORE 45
   The resident is fed by the nursing staff. This item includes syringe feeding when approved in writing by the physician.
   Tube fed—CODE 4 SCORE 90
   This applies the resident who is being tube fed only.
   I.V. CODE 5 SCORE 90
   This applies to the resident receiving I.V. therapy, or TPN for total nutrition and hydration. I.V. may be scored if required for more than five days of the month.
   Tube fed and assist—CODE 6 SCORE 110
   In those documented instances where a resident is tube fed and needs assistance with eating.
   Tube fed and totally dependent—CODE 7 SCORE 135
   In those documented instances where a resident is tube fed and is totally dependent in eating.
   Tube fed and I.V.—CODE 8 SCORE 135
   This covers the rare instance of a resident receiving both tube feeding and an I.V. (Do not also take points as a ‘Skilled Procedure,’ Item #12.)
   NOTE: LV. therapy refers to nutrition and hydration.
   Documentation: The Licensed Nursing Summary must verify ADL status at least monthly and specify the reason for assistance. The ADL flow sheet must document the daily functional status of the resident and the amount of supervision required.
   NOTE: If points are scored for feeding, points may not be scored under “Restorative Feeding” program.
7. Continence/Catheter
   Continent—CODE 1 SCORE 0
   The resident is continent or able to request assistance with toileting. Includes the resident who is dependent for transfers but is able to request assistance in advance of need.
   Incontinent Occasionally—CODE 2 SCORE 0
   “Occasionally” is defined as less than 15 days of the month. Use this code for the residents on bowel and bladder retraining.
   Incontinent and Toileted—CODE 3 SCORE 48
   This applies to the resident whose continence is maintained only through regular staff assistance in advance of need. The resident is not able to request assistance but is toileted at least every two hours. Includes incontinent care.
   Incontinent—CODE 4 SCORE 48
   This applies˜to regular incontinence due˜the resident's inability to control micturition or bowels, or to notify staff of need, and include incontinent care. (Cannot claim bladder incontinence if the resident is on a bladder-retraining program. Cannot claim bowel incontinence if the resident is on a bowel-retraining program.) This service may be claimed if the resident is regularly Incontinent at any time during the 24-hour period or requires routine colostomy, ileostomy, or urostomy care.
   Indwelling Catheter—CODE 5 SCORE 20
   Prescribed by a physician. Includes insertion, maintenance, catheter care, and cystostomy care and irrigation, if less than daily. (Cannot claim if the resident is on bladder-retraining program, Item #8). Please note that when catheter is irrigated at least daily then the service may be claimed as a “Skilled Procedure” in Item #12.
   Bowel Incontinent & Bladder Retraining—SCORE 18
   Enter CODE 2 for bladder and CODE 6 for bowel. Points for Bladder Retraining should be taken in Item #8.
   Documentation: The Licensed Nursing Summary must verify ADL status at least monthly. The ADL flow sheet must document daily functional status of the resident. SCORE for continence is based on the highest level of need in either Bladder or Bowel.
   Example: If Bladder is CODE 4, Incontinent, and Bowel is CODE 2, Incontinent Occasionally, SCORE 48.
   EXCEPTION: If Bladder is CODE 5, Indwelling Catheter, and Bowel is CODE 3, Incontinent and Toileted, or CODE 4, incontinent, SCORE 38.
8. Bladder/Bowel Retraining
   No Retraining Received—CODE 1 SCORE 0
   Bladder Retraining—CODE 2 SCORE 50
   A planned and documented program designed to reduce incontinence of urine. Include intermittent catheterization or clamping procedure for bladder retraining here, not to exceed 90 days. Routine toileting to prevent incontinence does not constitute a retraining program. Cannot claim in combination with “Bladder Incontinence,” Item #7.
   Bowel Retraining—CODE 3 SCORE 18
   A planned and documented program designed to reduce incontinence of feces, not to exceed 90 days. Cannot be claimed in combination with “Bowel Incontinence,” Item #7.
   Bladder and Bowel Retraining—CODE 4 SCORE 68
   Residents on both a bladder and bowel retraining program must meet the requirements listed above.
   Documentation: The Licensed Nursing Summary must verify the start date, the goal of the program, the resident's progress or lack thereof, and any revisions to the plan of care. The ADL flow sheet must document the daily functional status of the resident.
   NOTE: The clinical record must contain evidence that the patient has the capacity to comprehend and to participate in a program of bladder and bowel retraining.
9. Positioning
   Independent—Code 1 Score 0
   Assist—Code 2 Score 36
   The resident is essentially helpless to assist himself or herself and must be positioned every two hour while in bed or chair. Adjustment of restraints and routine skin care are provided in conjunction with position change.
   Documentation: The Licensed Nursing Summary must specify the resident's functional status and frequency of positioning and must indicate a reason for the assistance. Daily documentation must specify frequency and position on a positioning sheet or a restraint sheet.
10. Decubitus Prevention
   No Preventive Measures—Code 2 Score 10
   Pressure ulcer prevention includes routine diabetic foot care or the use of elbow or heel protectors or hand rolls. It may include the use of over the counter (nonprescription) creams such as: Desitin, Eucerin, A & D, Vaseline, Aloe Vesta, and Sween Cream, which are used to provide an extra increment of care. There must be documentation of a previous pressure ulcer and/or a current risk assessment using the Norton scale to indicate moderate or high risk of skin breakdown.
   NOTE 1: Points cannot be taken for the use of an air/water mattress, egg-crate pad, sheepskin or food cradles.
   NOTE 2: Incontinent treatment does not necessitate the need for preventive measures, unless the resident has had documented previous skin breakdown.
   NOTE 3: This item is concerned solely with preventive measures. Item # 11 applies to the treatment of an existing condition.
   Documentation: The daily nursing documentation must be specific to indicate the type of care, frequency, and site application. The Licensed Nursing Summary must specify the reason for preventive measures (previous skin breakdown or current risk assessment). Only the Norton scale, which must have been completed within the previous 90 days, will be accepted, or the skin breakdown must have been documented within the previous 90 days.
11. Skilled Procedure Daily/Decubitus
   Code the daily frequency of procedure(s) administered (maximum of nine). Enter 0 if no treatments are ordered.
   Procedures must be specifically ordered by a physician in writing and must be performed by a licensed nurse. Multiple decubiti at the same or different locations are considered on procedure if the same treatment is provided. A maximum of 10 points may be taken for the checking and/or changing of an occlusive dressing.
   Multiply daily frequency of each procedure by 10 and enter the total score.
   NOTE: In rare situations, different treatment may be ordered for multiple ducubiti in different locations. This may be claimed as more than one treatment. Identify the number of decubiti in each stage (maximum of nine).
   Documentation: Daily licensed nursing documentation must be recorded on the treatment sheet. At least weekly, the licensed nurse must record description, size, stage, treatment, and progress of decubitus or decubiti on the treatment sheet.
   Clinical stages are described as follows:
      Stage 1 Pre Ulcer: Characterized by unbroken skin surface. An area of induration, erythema, or blue/black discoloration of the skin that does not fade within 30 minutes after pressure has been removed.
      Stage 2 Ulcer: Moist, irregular, partial-thickness ulceration limited to the superficial epidermal and dermal layers.
      Stage 3 Ulcer: Full thickness extending into the subcutaneous adipose tissue.
      Stage 4 Ulcer: Necrotic ulcer extending into muscle, bone or joint structure.
12. Skilled Procedure Dally/Other

Skilled procedures are procedures or treatments other than decubitus treatment (Item #11) specifically ordered by a physician in writing that must be performed by a licensed nurse. See list below.
Code the daily frequency of skilled procedures in the single box (maximum of 9). Code 0 if no skilled procedures are needed. If more than one procedure is done daily, add the daily frequency for each procedure and enter the code.
EXAMPLE: If one procedure is done twice a day and another is done three times a day, the code is 5.
Multiply the sum of the daily frequency of each procedure or treatment by 10 and enter the total on the score line.
Respiratory therapy, continuous or daily oxygen, oxygen therapy, suctioning, and continuous bladder irrigation may be claimed for a maximum of one time per shift. The same treatment to different locations is considered one procedure if the same treatment is provided. A maximum of 10 points may be taken for the checking and/or changing of an occlusive dressing. Topical medications requiring a prescription may be taken for a maximum of 20 points for a dermatological condition involving epidermal and dermal layers.
Documentation: Daily licensed nursing documentation must specify treatment, frequency, description, and outcome. Specific observations must be recorded daily on a treatment sheet.
Enter appropriate procedure code(s) in the double boxes provided:
   01—Dressing Change
   02—Catheter Irrigation
   03—Intermittent Catheterization
   04—Eye Irrigation
   05—Ear Irrigation
   06—Care of Heparin Locks
   07—Oxygen Therapy (continuous or daily therapy)
   08—Tracheostomy Care
   09—Sterile Dressing
   10—Suctioning
   11—Not in use at this time
   12—Respiratory Therapy (includes the use of inhalation aerosols for the management of episodes of bronchospasm)
   13—New Colostomy irrigation
   14—Other
      Subtotal of Points Must be Calculated and Entered.
13. Special Attention
   CODING: A code must be entered for each box A through D. (See NOTE below for Box C.) Code 0 if not applicable. Code 1 if special attention was required for 15 days of the month reviewed (or 50% of the total days if less than a fuill month).
   SCORING: Enter 10% of Subtotal for Code 1, 2, or 3.
   A. Immobility: Code 1 if the resident is so heavy, helpless, or combative that two or more people are needed to change, position, transfer, or ambulate. This includes use of mechanical lifting devices, e.g., a Hoyer lift. The Nursing Summary must specify the resident's dysfunction and the ADL flow sheet must record the daily functional status.
   B. Severe Spasticity or Rigidity: Code I if the problem is of such magnitude that it severely limits personal care or ambulation, requiring two or more people. The Nursing Summary must specify the resident's dysfunction arid the ADL flow sheet must code the daily functional status.
   C. Behavioral Problems: Code 1, 2, or 3 may be used for behavioral problems. The disruptive behavior interferes with staff and/or other residents, causing the staff to stop or change what they are doing to control or alleviate the following disruptive behaviors
      i. Wandering—moves with no rational purpose, appears oblivious to needs or safety.
      ii. Verbally Abusive—threatens, screams, or curses.
      iii. Physically Abusive—hits, shoves, scratches, or sexually abuses others.
      iv. Socially Inappropriate or Disruptive Behavior—performs self-abusive acts, exhibits sexual behavior or disrobes in public, smears or throws food or feces, or rummages through others' belongings.
   Note Code 1, if behavior and intervention have been documented for 15-22 days.
      Code 2, if behavior and intervention have been documented for 23-29 days.
      Code 3, if behavior and intervention have been documented for 30 or 31 days.
   Required Documentation for Behavioral Problems.
   For Code 1, 2, or 3, a current active treatment plan for behavioral problems must be in the medical record.
   For Code 1, the Licensed Nursing Summary must verify and summarize the daily documented behavior(s), frequency, intervention(s), and the outcome of intervention(s):
   For Code 2 or 3, the daily Licensed Nursing Documentation must specify behavior(s), frequency, intervention(s), and outcome of intervention(s).
   For Code 2 or 3, a psychiatric assessment must document the disruptive behavior.
   D. Isolation: Gowns and gloves required due to communicable infection or severely impaired immune status.
14. Restorative Nursing
   Restorative nursing refers to care procedures that may require relearning after an illness such as a fractured hip or CVA.
   Implementation of specific types of resident re-teaching conducted at least five times per week by nursing staff. Intervention and progress must be well documented daily, with time limits and goals clearly stated. This may only be claimed for a period not to exceed 90 days.
   May claim points only for the limited time necessary to achieve the stated care plan objective or to prove it impractical, as shown by progress or lack of progress. Time limits for such services as AOL training, ostomy teaching, diabetic teaching, and restorative eating participation are those established during the resident-care planning process (maximum of 90 days).
   CODE—Enter procedure type(s) in the box(es).
   NOTE: The clinical record must contain evidence that the patient has the capacity to comprehend and to participate in the restorative program.
      0—None Required
      1—Activities of Daily Living—Dressing
      2—Activities of Daily Living—Personal Hygiene
      3—Activities of Daily Living—Restorative Eating
      4—Ostomy Care/Teaching
      5—Diabetic Teaching
      6—Ambulation
      7—Range of Motion
   SCORE—Enter 30 if any restorative nursing procedures are administered. The maximum score for this item is 30, regardless of the number of programs implemented. Enter 0 if none was provided.
   Documentation: The Licensed Nursing Summary must verify time limits, not to exceed 90 days, goals, progress, or lack of progress. The AOL flow sheet must document the daily functional status of the resident.
      Calculate and Enter the Grand Total of the Form (XXX.X). Enter the Corresponding Category Letter in the Single Box. See A3 for range of minutes per category.
      (No Points are Connected with the Next 10 Items.)
      All Items Must Have Entries.
15. Toilet Use (use of toileting equipment)
   Toilet Use refers to how the resident uses the toilet, bedpan, urinal, or commode, including transferring, if necessary, or positioning a bedpan/urinal, cleansing after elimination, and adjusting clothes prior to and after using the toilet The process involved in getting to the toilet may not be included here.
   CODE 1—Independent
   CODE 2—Assist
   CODE 3—Totally Dependent
   CODE 4—Not Toileted (Includes residents who do not use toileting equipment because of incontinence or because they have a catheter.)
16. Transfer
   Transfer refers to how the resident gets to the standing position or to sitting in a wheelchair. Mobility (Item 5) is how the resident walks indoors, once in a standing position, or wheels once in a wheelchair.
   CODE 1—Independent
   CODE 2—Assist
   CODE 3—Totally Dependent
   CODE 4—Bed bound
17. Mental Status
   Inability to remember dates or time, identify familiar locations or people, recall important aspects of recent events, or make straightforward judgments of such recent events, or make straightforward judgments of such a degree that the resident Is impaired newly every day in performance of basic activities of daily living, mobility, and adaptive tasks.
   Code as follows:
   CODE 1—Resident is not disoriented or impaired in memory.
   CODE 2—Resident is disoriented or impaired in memory daily.
   CODE 3—Mental status is not determined (includes only new admissions and those residents unable to communicate).
18. Restraint
   CODE 1—The resident does not have a written order for restraints.
   CODE 2—Restraint is ordered but not used on a regular daily basis.
   CODE 3—Restraint is ordered and used daily.
19. Activities Participation
   Code 1—Always active
   Code 2—Occasionally Active
   Code 3—Rarely Active or Not active
   Code 8—Not yet determined
20. Consultations
   Consultation is defined as a direct visit to a specific resident for reasons other than the required routine visit or admission screening.
   TYPE: Note which type of consultation(s) occurred by entering the appropriate code(s) in the column marked “TYPE”. (If more than three types apply, list the three that are most frequent). Enter 00 if none and 88 if not determined in the first set of boxes.
      00—none
      01—Physician
      02—Psychiatrist
      03—Dentist
      04—Podiatrist
      05—Physical Therapy
      06—Psychologist
      07—Dietitian
      08—Social Service
      09—Occupational Therapy
      10—Audiologist
      11—Speech Therapy
      12—Other
      88—Not determined
   FREQUENCY: Note the respective frequency of each consultation by entering the appropriate code(s) in the column marked “FREQ”:
      1—Daily
      2—2-3 Times per week’
      3—Weekly
      4—2-3 Times Monthly
      5—Monthly
      6—One Time Only (PRN)
21. Medications
   If selected types of medication have been ordered and administered, indicate the type of medication in the row marked “MED” using codes below. (Enter first code in the first box.) Enter 0 if none. Medications administered by that are not listed below should not be counted. Under each medication indicate the frequency using the codes below. Only codes listed in the instructions should be used. If more than four medications are administered, enter the ones administered most frequently.
      Meds (Prescription Only)
      0—none
      1—Tranquilizers
      2—Sedatives/hypnotics
      3—Anti-hypertensives
      4—Narcotics
      5—Pain Relievers (non-narcotic)
      6—Anti-Psychotics
      7—Antibiotics
      8—Antidepressants
      Frequency
      1—Regularly
      2—PRN
      3—One Time Only
22. Accidents/Contractures/Weight Change
   Indicate whether or not the resident has experienced an accident (an accident or incident report was completed) or weight change during the month by entering the appropriate code in each box:
      1—Yes
      2—No
   NOTE: A weight change is defined as an unplanned gain of eight or more pounds or loss of five or more pounds. (A weight change is considered planned when a resident is on a supplement diet, reduction diet, or diuretic program.)
   Indicate whether the patient has any contractures by entering the following cod in the box marked “C”. 1—Yes, 2—No.
23. Primary Diagnosis
   Use ICD-9-CM codes to indicate the diagnosis that is the principle reason for the resident's need for long term care services.
24. Secondary Diagnosis(es)
   List up to three ICD-9 CM codes for the conditions that have a major relationship to the resident's activities of daily living (ADL's) or cognitive or behavioral status. Leave blank if no secondary diagnoses are present.
   NOTE: ICD-9-CM code books are generally available at major booksellers.
      Affiliation
Enter the appropriate code for the person completing the MMQ:
Code 1—Nursing Facility Staff
Code 2—Division of Medical Assistance
Code 3—Other

The system and methods of the invention automatically assign the codes associated with the type and level of care needed for a particular patient when the CDA or other individual enters the data into a computer corresponding to a patient who has received care at a particular facility. The individual initiates the program of the invention by accessing a start up page (FIG. 1) and selecting the type of data entry forms to be entered. These data forms in the embodiment used to generate an MMQ are selected from a group consisting of Resident Information, CNA Flow Sheet, Summary Page 1, Summary Page 2, Summary Page 3, Summary Page 4, and Questions 17-24. These groups may be changed or modified depending on the application or jurisdiction.

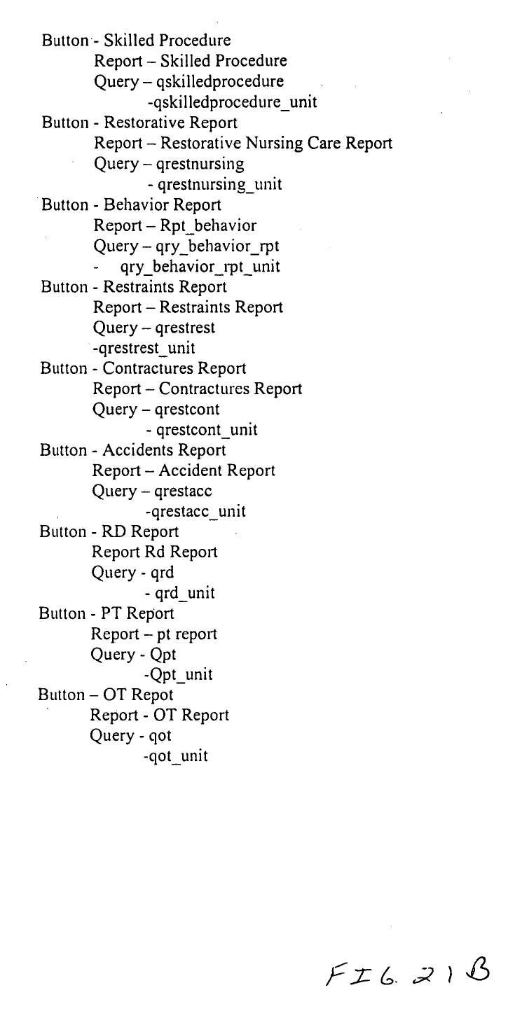

After the data entry form type is selected, the individual enters the data for a particular patient as prompted by the data entry forms. The program then automatically assigns patient care codes, using the logic and rules as the predetermined criteria, to the entered data. The data and assigned codes are then stored in the appropriate electronic databases corresponding to the information entered. When a report is desired or required, a user enters a report query such as those shown in FIG. 2 and FIG. 20. Once a report query is entered, the program of the invention automatically analyzes the information in the databases corresponding or having a predetermined relationship to the report query and converts the patient codes corresponding to report query into report codes. A report may then be generated in response to the report query.

Depending on the type of report query, patient scores, otherwise known as MMQ scores in the preferred embodiment for Massachusetts, may be calculated and printed on the generated report. For example, the method of the invention may further comprise the steps of calculating one or more patient scores based on one or more of the patient care codes and then reporting or printing the patient score the report when the report is generated.

Although specific features of the invention are shown in some drawings and not others, this is for convenience only as some feature may be combined with any or all of the other features in accordance with the invention.

Other embodiments will occur to those skilled in the art and are within the following claims:

1. A method of producing a medical information report corresponding to one or more facilities comprising the steps of,
entering data into a computer corresponding to a patient of said facility;
automatically analyzing said entered data and assigning one or more patient care codes, using one or more predetermined criteria, to said data and storing said data and said assigned codes in an electronic database;
entering a report query;
automatically analyzing and converting said patient codes corresponding to said report query into report codes;
generating a report in response to said report query.

2. The method of claim 1, further comprising the step of calculating one or more patient scores based on one or more of said patient care codes.

3. The method of claim 2, wherein said patient score is reported on said report.

4. The method of claim 1, wherein said report query is selected from a group of consisting of, licensed nursing summary, CNA code worksheet, Management Minutes Questionnaire, MMQ Evaluators Report, Administrative Report, Clinical Report, Consultant Report, and Archived Report.

5. The method of claim 1, further comprising the step of, providing one or more data entry forms to facilitate said step of entering data.

6. The method of claim 1, wherein said facility is a nursing home and said report comprises nursing home costs.

7. The method of claim 1, wherein said report comprises direct resident care costs, indirect care costs, administrative costs, and capital costs.

8. The method of claim 1, wherein said data entered in the step of entering data is selected from a group consisting of, direct resident care data, indirect care data, administrative data, and capital data.

9. The method of claim 1, wherein said codes are selected from a group of consisting of, bath codes, ambulation codes, behavior codes, bladder codes, bowel codes, decubitus codes, dressing codes, eating codes, grooming codes, intervention codes, toileting codes, and transfer codes.

10. The method of claim 1, wherein said report comprises an administrative report.

11. The method of claim 10, wherein said administrative report comprises a report selected from a group consisting of scores by unit, scores by payer source, staffing, and due dates.

12. The method of claim 1, wherein said report comprises a clinical report.

13. The method of claim 12, wherein said clinical report comprises a report selected from a group consisting of weight loss, weight gain, missing weight, Norton score, positioning, ambulation, mobility, skilled observations, decubitus treatments, skilled nursing procedures, restorative nursing, behavior report, restraints report, contracture report, and accidents report.

14. A system for producing a medical information report corresponding to a care facility comprising,
an electronic database for storing medical information data;
a means for entering said data into said database;
a plurality of data forms for facilitating the entry of data;
a means for automatically analyzing and converting said entered data into patient care codes; and
a means for generating a report comprising said patient care codes.

15. The system of claim 14, further comprising, a means for automatically analyzing and converting said patient care codes into patient scores.

16. The system of claim 15, wherein said report further comprises said patient scores.

17. The system of claim 14, wherein said patient care codes are selected from a group consisting of bath codes, ambulation codes, behavior codes, bladder codes, bowel codes, decubitus codes, dressing codes, eating codes, grooming codes, intervention codes, toileting codes, and transfer codes.

18. The system of claim 14, wherein said report comprises a Management Minutes Questionnaire report.

19. The system of claim 14, wherein said report comprises nursing home costs.

20. The system of claim 14, wherein said report comprises direct resident care costs, indirect care costs, administrative costs, and capital costs.
